(19) United States
(12) Patent Application Publication
(10) Pub. No.: US 2026/0300795 A1
(43) Pub. Date: Oct. 1, 2026

(54) SOLVING MULTI-OBJECTIVE COMPUTATIONAL PROBLEMS USING QUANTUM COMPUTING IN A LESS COMPUTATIONALLY EXPENSIVE MANNER

(71) Applicants: International Business Machines Corporation, Armonk, NY (US); Hyundai Motor Company, Seoul (KR); Kia Corporation, Seoul (KR)

(72) Inventors: Vaibhaw Kumar, Frederick, MD (US); Jae-Eun Park, Wappingers Falls, NY (US); Takahiro Yamamoto, Bunkyo-ku (JP); Mitsuharu Takeori, Kashiwa (JP); Dimitrios Alevras, West Chester, PA (US); Hanlae Jo, Seoul (KR); Semin Chun, Seoul (KR)

(21) Appl. No.: 19/093,750

(22) Filed: Mar. 28, 2025

(51) Int. Cl. G06N 10/60; G06N 10/20

(52) U.S. Cl. CPC G06N 10/60; G06N 10/20

(57) ABSTRACT

A method, system and computer program product for finding the optimal solution for multi-objective computational problems without being computationally expensive. The output of a parameterized quantum circuit is measured multiple times to obtain a set of samples, where each sample of the set of samples represents a point within a potential solution space of the multi-objective computational problem. An expectation value, which acts as a cost function, is calculated using the set of samples. The classical computer may then be utilized to adjust the parameters of the parameterized quantum circuit to minimize the cost function. A set of solutions on the Pareto front corresponding to a set of samples is then outputted by the classical computer in response to a convergence of the cost function, where such a set of samples was used to calculate the expectation value which acted as the cost function.

### TECHNICAL FIELD

The present disclosure relates generally to solving multiple-objective computational problems, and more particularly to solving multiple-objective computational problems, such as multi-objective combinatorial optimization problems, using quantum computing in a less computationally expensive manner.

### BACKGROUND

A multi-objective computational problem is an optimization problem where you need to simultaneously optimize two or more conflicting objectives. That is, a multi-objective computational problem is an optimization problem where the improvement of one objective often comes at the expense of worsening another objective requiring one to find a balance or “trade-off” between them resulting in a set of “Pareto optimal” solutions (referred to as the “Pareto front”) rather than a single best solution. The solution to a multi-objective problem is typically represented by a set of Pareto optimal solutions (Pareto front), where no solution can be improved in one objective without worsening another.

A Pareto front is a set of non-dominated solutions that are optimal in multi-objective optimization problems. That is, the Pareto front is a multi-dimensional and multi-objective equivalent of the optimal solution in single objective optimization problems. It is defined as the set of solutions that are non-dominated where no other solution strictly dominates them in terms of any objective.

An example of a multi-objective computational problem, where the solution is the Pareto front, is an electrical vehicle routing problem with multiple objectives. The Pareto front represents a set of optimal solutions where it is impossible to improve one objective (e.g., minimizing travel distance) without worsening another objective (e.g., maximizing battery life) thereby illustrating the best trade-offs between competing goals when routing electric vehicles. Since electrical vehicle routing problems often involve minimizing both travel distance and energy consumption (which can be conflicting), it is typically treated as a multi-objective optimization problem, where the Pareto front identifies the set of solutions that cannot be improved in one objective without sacrificing the other. By visualizing the Pareto front, decision-makers can see which solutions offer the best balance between minimizing travel distance and maximizing battery life based on their specific needs. Examples of objectives in an electrical vehicle routing problem that might be included in a Pareto front include the total travel distance (e.g., minimizing the overall distance traveled by the electric vehicles), energy consumption (e.g., minimizing the total amount of energy used by the vehicles on their routes), and charging time (e.g., minimizing the time spent charging at charging stations).

Such multi-objective computational problem, where the solution is a Pareto front, may be classified as NP (nondeterministic polynomial time)-hard problems. NP-hard problems are a class of computational problems that are extremely difficult to solve. When dealing with multi-objective optimization problems where multiple competing objectives need to be optimized simultaneously, finding the Pareto front (set of optimal solutions representing the best trade-offs between those objectives) can be a NP-hard problem (i.e., computationally challenging).

Unfortunately, state of the art software tools to solve optimization problems, such as CPLEX®, are not capable of solving such NP-hard problems.

Hence, there is not currently a means for finding the optimal solution for NP-hard problems, such as multi-objective computational problems where the solution is a Pareto front, without being computationally expensive.

### SUMMARY

In one embodiment of the present disclosure, a method for solving multi-objective computational problems comprises measuring output of a parameterized quantum circuit multiple times to obtain a set of samples, where each sample of the set of samples represents a point within a potential solution space of a multi-objective computational problem. The method further comprises calculating an expectation value, which acts as a cost function, using the set of samples. The method additionally comprises adjusting parameters of the parameterized quantum circuit to minimize the cost function. Furthermore, the method comprises outputting a set of solutions on a Pareto front in response to a convergence of the cost function.

Furthermore, in one embodiment of the present disclosure, the method additionally comprises preparing a trial state using the parameterized quantum circuit.

Additionally, in one embodiment of the present disclosure, the method further comprises measuring the output of the parameterized quantum circuit multiples times to obtain the set of samples by executing the parameterized quantum circuit multiple times using the trial state.

Furthermore, in one embodiment of the present disclosure, the method additionally comprises updating the trial state in response to the cost function not converging.

Additionally, in one embodiment of the present disclosure, the method further comprises measuring the output of the parameterized quantum circuit multiples times to obtain a second set of samples by executing the parameterized quantum circuit multiple times using the updated trial state.

Furthermore, in one embodiment of the present disclosure, the cost function converges in response to an absolute difference in cost function values between consecutive iterations being less than a threshold value.

Other forms of the embodiments of the method described above are in a system and in a computer program product.

In one embodiment of the present disclosure, a method for solving multi-objective computational problems comprises measuring output of a parameterized quantum circuit multiple times to obtain a first set of samples, where the first set of samples represents a first set of candidate solutions that represents a feasible solution space of a first multiple-objective function of a multi-objective computational problem for a first trial. The method further comprises calculating an expectation value, which acts as a cost function, using the first set of samples. The method additionally comprises adjusting a parameter of the parameterized quantum circuit to minimize the cost function. Furthermore, the method comprises outputting a first set of solutions for the first multiple-objective function of the multi-objective computational problem for the first trial in response to a convergence of the cost function.

Furthermore, in one embodiment of the present disclosure, the method additionally comprises preparing a trial state using the parameterized quantum circuit.

Additionally, in one embodiment of the present disclosure, the method further comprises measuring the output of the parameterized quantum circuit multiple times to obtain the first set of samples by executing the parameterized quantum circuit multiple times using the trial state.

Furthermore, in one embodiment of the present disclosure, the method additionally comprises updating the trial state in response to the cost function not converging.

Additionally, in one embodiment of the present disclosure, the method further comprises measuring the output of the parameterized quantum circuit multiple times to obtain a second set of samples by executing the parameterized quantum circuit multiple times using the updated trial state, where the second set of samples represents a second set of candidate solutions that represents a feasible solution space of a second multiple-objective function of the multi-objective computational problem for a second trial.

Furthermore, in one embodiment of the present disclosure, the method additionally comprises measuring the output of the parameterized quantum circuit multiple times to obtain a second set of samples, where the second set of samples represents a second set of candidate solutions that represents a feasible solution space of a second multiple-objective function of the multi-objective computational problem for a second trial. The method further comprises calculating the expectation value, which acts as the cost function, using the second set of samples. The method additionally comprises adjusting the parameter of the parameterized quantum circuit to minimize the cost function. Furthermore, the method comprises outputting a second set of solutions for the second multiple-objective function of the multi-objective computational problem for the second trial in response to a convergence of the cost function.

Additionally, in one embodiment of the present disclosure, the method further comprises outputting a set of solutions on a Pareto front corresponding to those previously outputted values for the first and second multiple-objective functions that are located on the Pareto front.

Other forms of the embodiments of the method described above are in a system and in a computer program product.

Accordingly, embodiments of the present disclosure solve multi-objective computational problems, such as muti-objective combinatorial optimization problems, where the solution is a Pareto front, in a less computationally expensive manner using quantum computing.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components of the classical computer for solving a multi-objective computational problem, such as a multi-objective combinatorial optimization problem, where the solution is a Pareto front, in a less computationally expensive manner using quantum computing in accordance with an embodiment of the present disclosure;

FIG. 3 illustrates solving the set of solutions on the Pareto front based on performing MOP solver trials in accordance with an embodiment of the present disclosure;

FIG. 4 illustrates an embodiment of the present disclosure of the hardware configuration of the classical computer which is representative of a hardware environment for practicing the present disclosure;

FIG. 5 is a flowchart of a method for solving multi-objective computational problems, such as multi-objective combinatorial optimization problems, where the solution is a Pareto front, in a less computationally expensive manner using quantum computing in accordance with an embodiment of the present disclosure; and

FIG. 6 is a flowchart of an alternative method for solving multi-objective computational problems, such as multi-objective combinatorial optimization problems, where the solution is a Pareto front, in a less computationally expensive manner using quantum computing in accordance with an embodiment of the present disclosure.

### DETAILED DESCRIPTION

In one embodiment of the present disclosure, a method for solving multi-objective computational problems comprises measuring output of a parameterized quantum circuit multiple times to obtain a set of samples, where each sample of the set of samples represents a point within a potential solution space of a multi-objective computational problem. The method further comprises calculating an expectation value, which acts as a cost function, using the set of samples. The method additionally comprises adjusting parameters of the parameterized quantum circuit to minimize the cost function. Furthermore, the method comprises outputting a set of solutions on a Pareto front in response to a convergence of the cost function.

In this manner, multi-objective computational problems, such as muti-objective combinatorial optimization problems, where the solution is a Pareto front, can be solved in a less computationally expensive manner using quantum computing.

Furthermore, in one embodiment of the present disclosure, the method additionally comprises preparing a trial state using the parameterized quantum circuit.

In this manner, there is an initial guess for the quantum state for solving the multi-objective computational problem.

Additionally, in one embodiment of the present disclosure, the method further comprises measuring the output of the parameterized quantum circuit multiples times to obtain the set of samples by executing the parameterized quantum circuit multiple times using the trial state.

In this manner, a set of samples is obtained, where each sample of the set of samples represents a point within the potential solution space of the multi-objective computational problem, which corresponds to a bitstring that belongs to the Pareto front. The bitstrings of the Pareto front in the multi-objective computational problem, such as a multi-objective combinatorial optimization problem, represent the solutions on the Pareto front, where each bit in the string corresponds to a decision variable in the problem. The set of all such bitstrings on the Pareto front represents the optimal trade-offs between different objectives without any solution being strictly dominated by another.

Furthermore, in one embodiment of the present disclosure, the method additionally comprises updating the trial state in response to the cost function not converging.

In this manner, the cost function is minimized by iteratively updating the initial guess for the quantum state by adjusting the parameters within the parameterized quantum circuit, such as a designed quantum circuit (ansatz).

Additionally, in one embodiment of the present disclosure, the method further comprises measuring the output of the parameterized quantum circuit multiples times to obtain a second set of samples by executing the parameterized quantum circuit multiple times using the updated trial state.

In this manner, a new set of samples representing a more accurate set of solutions on the Pareto front may be provided.

Furthermore, in one embodiment of the present disclosure, the cost function converges in response to an absolute difference in cost function values between consecutive iterations being less than a threshold value.

In this manner, it is known when the optimal set of solutions on the Pareto front has been identified.

Other forms of the embodiments of the method described above are in a system and in a computer program product.

In one embodiment of the present disclosure, a method for solving multi-objective computational problems comprises measuring output of a parameterized quantum circuit multiple times to obtain a first set of samples, where the first set of samples represents a first set of candidate solutions that represents a feasible solution space of a first multiple-objective function of a multi-objective computational problem for a first trial. The method further comprises calculating an expectation value, which acts as a cost function, using the first set of samples. The method additionally comprises adjusting a parameter of the parameterized quantum circuit to minimize the cost function. Furthermore, the method comprises outputting a first set of solutions for the first multiple-objective function of the multi-objective computational problem for the first trial in response to a convergence of the cost function.

In this manner, multi-objective computational problems, such as muti-objective combinatorial optimization problems, where the solution is a Pareto front, can be solved in a less computationally expensive manner using quantum computing.

Furthermore, in one embodiment of the present disclosure, the method additionally comprises preparing a trial state using the parameterized quantum circuit.

In this manner, there is an initial guess for the quantum state for solving the multi-objective computational problem.

Additionally, in one embodiment of the present disclosure, the method further comprises measuring the output of the parameterized quantum circuit multiple times to obtain the first set of samples by executing the parameterized quantum circuit multiple times using the trial state.

In this manner, a set of samples is obtained, where each sample of the set of samples represents a set of candidate solutions that represents a feasible solution space of a multiple-objective function of the multi-objective computational problem for a trial.

Furthermore, in one embodiment of the present disclosure, the method additionally comprises updating the trial state in response to the cost function not converging.

In this manner, the cost function is minimized by iteratively updating the initial guess for the quantum state by adjusting the parameter within the parameterized quantum circuit, such as a designed quantum circuit (ansatz).

Additionally, in one embodiment of the present disclosure, the method further comprises measuring the output of the parameterized quantum circuit multiple times to obtain a second set of samples by executing the parameterized quantum circuit multiple times using the updated trial state, where the second set of samples represents a second set of candidate solutions that represents a feasible solution space of a second multiple-objective function of the multi-objective computational problem for a second trial.

In this manner, an additional set of candidate solutions that represents a feasible solution space of a multiple-objective function of the multi-objective computational problem for another trial may be obtained. Such an additional set of candidate solutions is used to identify the set of solutions on the Pareto front.

Furthermore, in one embodiment of the present disclosure, the method additionally comprises measuring the output of the parameterized quantum circuit multiple times to obtain a second set of samples, where the second set of samples represents a second set of candidate solutions that represents a feasible solution space of a second multiple-objective function of the multi-objective computational problem for a second trial. The method further comprises calculating the expectation value, which acts as the cost function, using the second set of samples. The method additionally comprises adjusting the parameter of the parameterized quantum circuit to minimize the cost function. Furthermore, the method comprises outputting a second set of solutions for the second multiple-objective function of the multi-objective computational problem for the second trial in response to a convergence of the cost function.

In this manner, an additional set of candidate solutions that represents a feasible solution space of a multiple-objective function of the multi-objective computational problem for another trial may be obtained. Such an additional set of candidate solutions is used to identify the set of solutions on the Pareto front.

Additionally, in one embodiment of the present disclosure, the method further comprises outputting a set of solutions on a Pareto front corresponding to those previously outputted values for the first and second multiple-objective functions that are located on the Pareto front.

In this manner, the set of solutions on the Pareto front which solves the multi-objective computational problem is outputted.

Other forms of the embodiments of the method described above are in a system and in a computer program product.

As stated above, a multi-objective computational problem is an optimization problem where you need to simultaneously optimize two or more conflicting objectives. That is, a multi-objective computational problem is an optimization problem where the improvement of one objective often comes at the expense of worsening another objective requiring one to find a balance or “trade-off” between them resulting in a set of “Pareto optimal” solutions (referred to as the “Pareto front”) rather than a single best solution. The solution to a multi-objective problem is typically represented by a set of Pareto optimal solutions (Pareto front), where no solution can be improved in one objective without worsening another.

A Pareto front is a set of non-dominated solutions that are optimal in multi-objective optimization problems. That is, the Pareto front is a multi-dimensional and multi-objective equivalent of the optimal solution in single objective optimization problems. It is defined as the set of solutions that are non-dominated where no other solution strictly dominates them in terms of any objective.

An example of a multi-objective computational problem, where the solution is the Pareto front, is an electrical vehicle routing problem with multiple objectives. The Pareto front represents a set of optimal solutions where it is impossible to improve one objective (e.g., minimizing travel distance) without worsening another objective (e.g., maximizing battery life) thereby illustrating the best trade-offs between competing goals when routing electric vehicles. Since electrical vehicle routing problems often involve minimizing both travel distance and energy consumption (which can be conflicting), it is typically treated as a multi-objective optimization problem, where the Pareto front identifies the set of solutions that cannot be improved in one objective without sacrificing the other. By visualizing the Pareto front, decision-makers can see which solutions offer the best balance between minimizing travel distance and maximizing battery life based on their specific needs. Examples of objectives in an electrical vehicle routing problem that might be included in a Pareto front include the total travel distance (e.g., minimizing the overall distance traveled by the electric vehicles), energy consumption (e.g., minimizing the total amount of energy used by the vehicles on their routes), and charging time (e.g., minimizing the time spent charging at charging stations).

Such multi-objective computational problem, where the solution is a Pareto front, may be classified as NP (nondeterministic polynomial time)-hard problems. NP-hard problems are a class of computational problems that are extremely difficult to solve. When dealing with multi-objective optimization problems where multiple competing objectives need to be optimized simultaneously, finding the Pareto front (set of optimal solutions representing the best trade-offs between those objectives) can be a NP-hard problem (i.e., computationally challenging).

Unfortunately, state of the art software tools to solve optimization problems, such as CPLEX®, are not capable of solving such NP-hard problems.

Hence, there is not currently a means for finding the optimal solution for NP-hard problems, such as multi-objective computational problems where the solution is a Pareto front, without being computationally expensive.

The embodiments of the present disclosure provide the means for finding the optimal solution for multi-objective computational problems without being computationally expensive. In one embodiment, the output of a parameterized quantum circuit is measured multiple times to obtain a set of samples, where each sample of the set of samples represents a point within a potential solution space of the multi-objective computational problem. A parameterized quantum circuit, as used herein, refers to a quantum circuit where certain gates or operations contain adjustable parameters allowing the circuit's behavior to be fine-tuned by changing the values of these parameters. A set of samples, as used herein, represents the probability distribution of the parameterized quantum circuit's outputs. An expectation value, which acts as a cost function, is calculated based on the multi-objective computational problem using the set of samples. In one embodiment, the expectation value is calculated by taking the average of the measured outputs (samples) from the parameterized quantum circuit. An expectation value, as used herein, acts as a cost function by providing a single, weighted average value of all possible measurement results based on their probabilities. The classical computer may then be utilized to adjust the parameters of the parameterized quantum circuit to minimize the cost function. For example, in one embodiment, the calculated cost function is fed into a classical optimizer which updates the circuit parameters (θ) that aim to lower the cost function in the next iteration. That is, the cost function is minimized by iteratively updating the parameterized quantum circuit's parameters effectively tuning the quantum state outputted by the parameterized quantum circuit to achieve a desired outcome. A set of solutions on the Pareto front corresponding to a set of samples is then outputted by the classical computer in response to a convergence of the cost function, where such a set of samples was used to calculate the expectation value which acted as the cost function. In one embodiment, convergence is said to occur when the absolute difference in cost function values between consecutive iterations is less than a threshold value, which may be user-designated. In this manner, multi-objective computational problems, where the solution is a Pareto front, may be solved without being computationally expensive using quantum computing.

Alternatively, in one embodiment, the output of a parameterized quantum circuit is measured multiple times to obtain a set of samples, where the set of samples represents a set of candidate solutions that represents a feasible solution space of a multiple-objective function of the multi-objective computational problem for a trial. The expectation value, which acts as a cost function, is then calculated using the set of samples. The classical computer may then be utilized to adjust the parameter of the parameterized quantum circuit to minimize the cost function. The cost function is minimized by iteratively updating the parameterized quantum circuit's parameter effectively tuning the quantum state outputted by the parameterized quantum circuit to achieve a desired outcome. A set of solutions (corresponds to the set of samples used to calculate the expectation value which acts as the cost function) for the multiple-objective function of the multi-objective computational problem for the trail is then outputted in response to a convergence of the cost function. The above-described process is repeated for other trials until there are no further trials to be executed. Upon executing all the trials, the set of solutions on the Pareto front corresponding to those previously outputted values for the multiple-objective function Fₖ for trial k that are located on the Pareto front are outputted. In this manner, multi-objective computational problems, where the solution is a Pareto front, may be solved without being computationally expensive using quantum computing.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

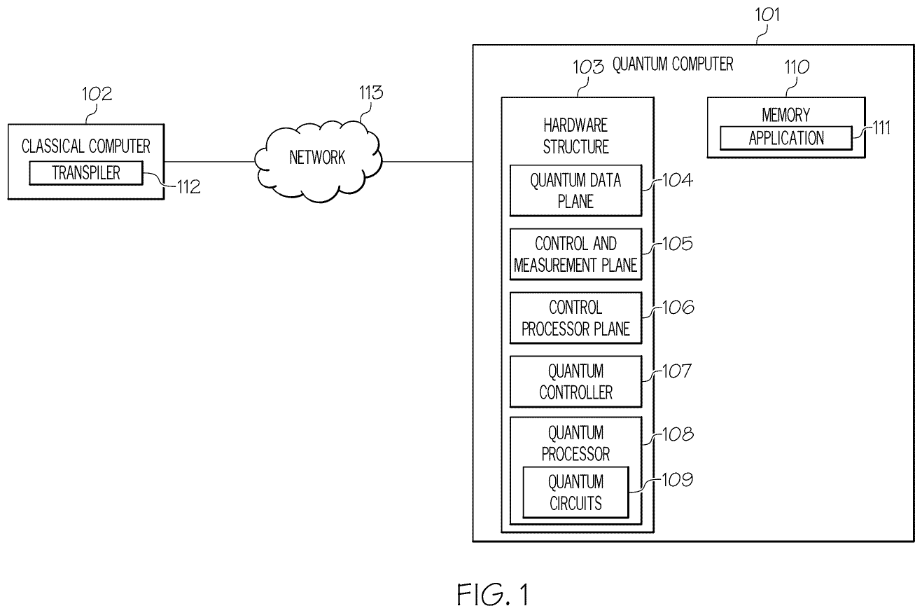

Referring now to the Figures in detail, FIG. 1 illustrates an embodiment of the present disclosure of a communication system 100 for practicing the principles of the present disclosure. Communication system 100 includes a quantum computer 101 configured to perform quantum computations, such as the types of computations that harness the collective properties of quantum states, such as superposition, interference, and entanglement, as well as a classical computer 102 in which information is stored in bits that are represented logically by either a 0 (off) or a 1 (on). Examples of classical computer 102 include, but are not limited to, a portable computing unit, a Personal Digital Assistant (PDA), a laptop computer, a mobile device, a tablet personal computer, a smartphone, a mobile phone, a navigation device, a gaming unit, a desktop computer system, a workstation, and the like configured with the capability of connecting to network 113 (discussed below).

In one embodiment, classical computer 102 is used to set up the state of quantum bits in quantum computer 101 and then quantum computer 101 starts the quantum process. Furthermore, in one embodiment, classical computer 102 is configured to solve multi-objective computational problems, such as multi-objective combinatorial optimization problems, where the solution is a Pareto front, without being computationally expensive using quantum computing.

In one embodiment, a hardware structure 103 of quantum computer 101 includes a quantum data plane 104, a control and measurement plane 105, a control processor plane 106, a quantum controller 107, and a quantum processor 108. While depicted as being located on a single machine, quantum data plane 104, control and measurement plane 105, and control processor plane 106 may be distributed across multiple computing machines, such as in a cloud computing architecture, and communicate with quantum controller 107, which may be located in close proximity to quantum processor 108.

Quantum data plane 104 includes the physical qubits or quantum bits (basic unit of quantum information in which a qubit is a two-state (or two-level) quantum-mechanical system) and the structures needed to hold them in place. In one embodiment, quantum data plane 104 contains any support circuitry needed to measure the qubits' state and perform gate operations on the physical qubits for a gate-based system or control the Hamiltonian for an analog computer. In one embodiment, control signals routed to the selected qubit(s) set a state of the Hamiltonian. For gate-based systems, since some qubit operations require two qubits, quantum data plane 104 provides a programmable “wiring” network that enables two or more qubits to interact.

Control and measurement plane 105 converts the digital signals of quantum controller 107, which indicates what quantum operations are to be performed, to the analog control signals needed to perform the operations on the qubits in quantum data plane 104. In one embodiment, control and measurement plane 105 converts the analog output of the measurements of qubits in quantum data plane 104 to classical binary data that quantum controller 107 can handle.

Control processor plane 106 identifies and triggers the sequence of quantum gate operations and measurements (which are subsequently carried out by control and measurement plane 105 on quantum data plane 104). These sequences execute the program, provided by quantum processor 108, for implementing a quantum algorithm.

In one embodiment, control processor plane 106 runs the quantum error correction algorithm (if quantum computer 101 is error corrected).

In one embodiment, quantum processor 108 uses qubits to perform computational tasks. In the particular realms where quantum mechanics operate, particles of matter can exist in multiple states, such as an “on” state, an “off” state, and both “on” and “off” states simultaneously. Quantum processor 108 harnesses these quantum states of matter to output signals that are usable in data computing.

In one embodiment, quantum processor 108 performs algorithms which conventional processors are incapable of performing efficiently.

In one embodiment, quantum processor 108 includes one or more quantum circuits 109. Quantum circuits 109 may collectively or individually be referred to as quantum circuits 109 or quantum circuit 109, respectively. A “quantum circuit 109,” as used herein, refers to a model for quantum computation in which a computation is a sequence of quantum logic gates, measurements, initializations of qubits to known values and possibly other actions. A “quantum logic gate,” as used herein, is a reversible unitary transformation on at least one qubit. Quantum logic gates, in contrast to classical logic gates, are all reversible. Examples of quantum logic gates include RX (also identified as Rx) (performs e^{jθX/2}, which corresponds to a rotation of the qubit state around the X-axis by the given angle theta θ on the Bloch sphere), RY (also identified as Ry) (performs e^{jθY/2}, which corresponds to a rotation of the qubit state around the Y-axis by the given angle theta θ on the Bloch sphere), RXX (performs the operation e^{(-iθX⊗X/2)} on the input qubit), RZZ (takes in one input, an angle theta θ expressed in radians, and it acts on two qubits), etc. In one embodiment, quantum circuits 109 are written such that the horizontal axis is time, starting at the left-hand side and ending at the right-hand side.

Furthermore, in one embodiment, quantum circuit 109 corresponds to a command structure provided to control processor plane 106 on how to operate control and measurement plane 105 to run the algorithm on quantum data plane 104/quantum processor 108.

Furthermore, quantum computer 101 includes memory 110, which may correspond to quantum memory. In one embodiment, memory 110 is a set of quantum bits that store quantum states for later retrieval. The state stored in quantum memory 110 can retain quantum superposition.

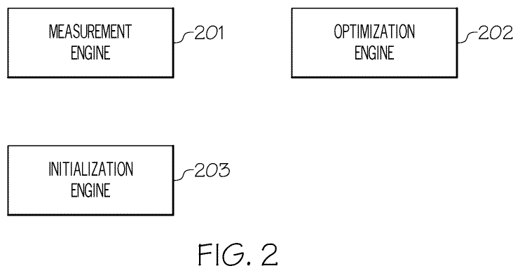

In one embodiment, memory 110 stores an application 111 that may be configured to implement one or more of the methods described herein in accordance with one or more embodiments. For example, application 111 may implement a program for solving multi-objective computational problems, such as multi-objective combinatorial optimization problems, where the solution is a Pareto front, without being computationally expensive using quantum computing as discussed further below in connection with FIGS. 2-3 and 5-6. Examples of memory 110 include light quantum memory, solid quantum memory, gradient echo memory, electromagnetically induced transparency, etc.

Furthermore, in one embodiment, classical computer 102 includes a “transpiler 112,” which as used herein, is configured to rewrite an abstract quantum circuit 109 into a functionally equivalent one that matches the constraints and characteristics of a specific target quantum device. In one embodiment, transpiler 112 (e.g., qiskit.transpiler, where Qiskit® is an open-source software development kit for working with quantum computers at the level of circuits, pulses, and algorithms) rewrites a given input circuit to match the topology of a specific quantum device and/or to optimize the quantum circuit for execution. In one embodiment, transpiler 112 converts a trained machine learning model upon execution on quantum hardware 103 to its elementary instructions and maps it to physical qubits.

In one embodiment, the number of qubits (basic unit of quantum information in which a qubit is a two-state (or two-level) quantum-mechanical system) is determined by the number of features in the data. This processing stage may include multiple layers of parameterized gates. As a result, in one embodiment, the number of trainable parameters is (number of features)*(number of layers).

Furthermore, as shown in FIG. 1, classical computer 102, which is used to set up the state of quantum bits in quantum computer 101, may be connected to quantum computer 101 via network 113.

Network 113 may be, for example, a quantum network, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, a cellular network and various combinations thereof, etc. Other networks, whose descriptions are omitted here for brevity, may also be used in conjunction with system 100 of FIG. 1 without departing from the scope of the present disclosure.

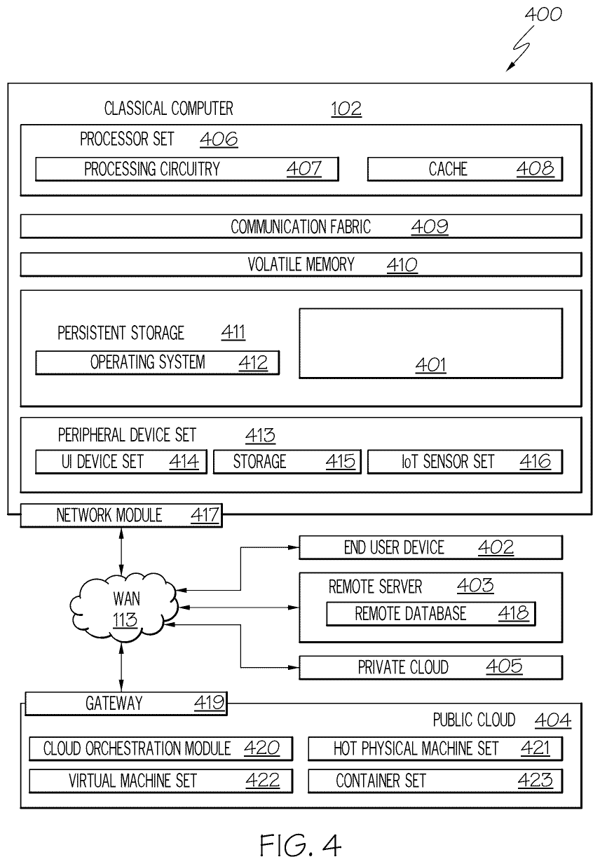

Furthermore, classical computer 102 is configured to solve multi-objective computational problems, such as multi-objective combinatorial optimization problems, where the solution is a Pareto front, without being computationally expensive using quantum computing as discussed further below in connection with FIGS. 2-3 and 5-6. A description of the software components of classical computer 102 is provided below in connection with FIG. 2 and a description of the hardware configuration of classical computer 102 is provided further below in connection with FIG. 4.

System 100 is not to be limited in scope to any one particular network architecture. System 100 may include any number of quantum computers 101, classical computers 102, and networks 113.

A discussion regarding the software components used by classical computer 102 for solving multi-objective computational problems, such as multi-objective combinatorial optimization problems, where the solution is a Pareto front, without being computationally expensive using quantum computing is provided below in connection with FIG. 2.

FIG. 2 is a diagram of the software components of classical computer 102 (FIG. 1) for solving a multi-objective computational problem, such as a multi-objective combinatorial optimization problem, where the solution is a Pareto front, in a less computationally expensive manner using quantum computing in accordance with an embodiment of the present disclosure.

Referring to FIG. 2, in conjunction with FIG. 1, classical computer 102 includes a measurement engine 201 configured to prepare a trial state using a parameterized quantum circuit (e.g., quantum circuit 109).

A “trial state,” as used herein, refers to an initial guess for the quantum state to be found, which is then refined through optimization. A “parameterized quantum circuit,” as used herein, refers to a quantum circuit where certain gates or operations contain adjustable parameters allowing the circuit's behavior to be fine-tuned by changing the values of these parameters.

In one embodiment, measurement engine 201 prepares a trial state using a parameterized quantum circuit by designing an ansatz. The ansatz, as used herein, refers to the specific structure of the parameterized quantum circuit used to prepare the trial state. In one embodiment, a suitable quantum circuit architecture with parameterized gates (e.g., rotation gates) is selected based on the problem, such as a multi-objective combinatorial optimization problem, to be solved. In one embodiment, initial values are then assigned to the parameters in the ansatz. The parameterized quantum circuit is then run on a quantum computer (e.g., quantum computer 101) to prepare the trial state.

In one embodiment, measurement engine 201 measures the output of the parameterized quantum circuit multiple times to obtain a set of samples by executing the parameterized quantum circuit multiple times using the trial state. A “set of samples,” as used herein, represents the probability distribution of the parameterized quantum circuit's outputs. In one embodiment, each sample of the set of samples represents a point within the potential solution space of the multi-objective computational problem.

In one embodiment, measurement engine 201 executes the parameterized quantum circuit with its set of parameters multiple times, where each run results in a single measurement outcome, which collectively forms the set of samples. As discussed further below, such a set of samples is used to calculate an expectation value that represents the average behavior of the parameterized quantum circuit under those parameters.

In one embodiment, at the end of each circuit execution, measurement engine 201 performs a measurement of the quantum state produced by the parameterized quantum circuit, which represents a point within the potential solution space of the multi-objective computational problem. In one embodiment, such a point corresponds to a bitstring that belongs to the Pareto front. In one embodiment, the bitstrings of the Pareto front in a multi-objective computational problem, such as a multi-objective combinatorial optimization problem, represent the solutions on the Pareto front, where each bit in the string corresponds to a decision variable in the problem. The set of all such bitstrings on the Pareto front represents the optimal trade-offs between different objectives without any solution being strictly dominated by another.

In one embodiment, measurement engine 201 executes the parameterized quantum circuit with the current parameter values on a quantum computer (e.g., quantum computer 101). The output quantum state of the parameterized quantum circuit is measured to obtain a single sample. Such a process is repeated for a predefined number of “shots” to collect a set of samples. Such a set of samples represents the set of candidate solutions that represents the feasible solution space of the multi-objective computational problem, such as the multi-objective combinatorial optimization problem.

Measurement engine 201 utilizes various software tools for preparing the trial state and measuring the output of the parameterized quantum circuit multiple times to obtain a set of samples as discussed above, including, but not limited to, Qiskit®, Cirq®, PennyLane®, etc.

Furthermore, measurement engine 201 is configured to calculate an expectation value, which acts as a cost function, based on the multi-objective computational problem, such as the multi-objective combinatorial optimization problem, using the set of samples. An “expectation value,” as used herein, acts as a cost function by providing a single, weighted average value of all possible measurement results based on their probabilities.

In one embodiment, measurement engine 201 calculates the expectation value by taking the average of the measured outputs (samples) from the parameterized quantum circuit, where each sample represents a measurement of the quantum state produced by the parameterized quantum circuit with specific parameter settings weighted by the corresponding probability of that outcome.

Measurement engine 201 utilizes various software tools for calculating the expectation value in such a manner, including, but not limited to, SciPy, NumPy®, PyMOO, etc.

Classical computer 102 further includes an optimization engine 202 configured to adjust the parameters of the parametrized quantum circuit to minimize the cost function. In one embodiment, optimization engine 202 utilizes classical computer 102 to adjust the parameters of the parametrized quantum circuit to minimize the cost function.

For example, in one embodiment, optimization engine 202 updates the parameters (θ) of the parameterized quantum circuit that aim to lower the cost function in the next iteration. That is, the cost function is minimized by iteratively updating the parameterized quantum circuit's parameters effectively tuning the quantum state outputted by the parameterized quantum circuit to achieve a desired outcome.

In one embodiment, optimization engine 202 performs such an optimization which is mathematically shown below.

$$ℒ ( \vec{θ} ) = {\sum }_{{\vec{x}}_{i} ∈ S} [ p ( {\vec{x}}_{i} ; \vec{θ} ) ( \frac{1}{\vert Q \vert + 1} {\sum }_{k = 1}^{K} {\sum }_{{x}_{j} ∈ Q} sign ( {f}_{k} ( {\vec{x}}_{i} ) - {f}_{k} ( {\vec{x}}_{j} ) ) + λ {‖ A {\vec{x}}_{i} - \vec{b} ‖}^{2} ) ] ,$$

$$sign ( a ) = \{ \begin{matrix}- 1 & if a \leq 0 \\ 1 & if a > 0\end{matrix} , and$$

$$Q = \{ {\vec{x}}_{j} ∈ S : {f}_{k} ( {\vec{x}}_{j} ) \geq {f}_{k} ( {\vec{u}}_{j} ) ∀ K ∈ [ 1 … K ] or {f}_{k} ( {\vec{x}}_{j} ) \leq {f}_{k} ( {\vec{x}}_{i} ) ∀ K ∈ [ 1 … K ] ,$$

where matrix A and \vec{b} define the constraints of the multi-objective computational problem, such as the multi-objective combinatorial optimization problem, fₖ are the objective functions, and \vec{x} denotes a bitstring,

In one embodiment, optimization engine 202 adjusts the parameters of the parameterized quantum circuit to minimize the expectation value, which acts as the cost function, by employing a classical optimization algorithm, such as gradient descent. In one embodiment, such parameters are updated based on the calculated gradient of the cost function with respect to those parameters.

In one embodiment, optimization engine 202 uses a technique, such as the parameter shift rule, to calculate the gradient of the cost function with respect to each parameter in the parameterized quantum circuit. Based on the calculated gradient, the parameters of the parameterized quantum circuit are updated in the direction that minimizes the cost function.

Furthermore, in one embodiment, optimization engine 202 determines if the cost function converges to find a suitable solution, where the “suitable solution” in this embodiment, as used herein, refers to the set of solutions on the Pareto front. In one embodiment, the set of solutions on the Pareto front corresponds to the set of samples (representing the feasible solution space of the multi-objective computational problem, such as the multi-objective combinatorial optimization problem) that was used to calculate the expectation value, which acted as the cost function that converges.

In one embodiment, convergence is said to occur when the absolute difference in cost function values between consecutive iterations is less than a threshold value, which may be user-designated.

If the cost function converges, then optimization engine 202 outputs the set of solutions on the Pareto front, which corresponds to the set of samples (representing the feasible solution space of the multi-objective computational problem, such as the multi-objective combinatorial optimization problem) that was used to calculate the expectation value, which acted as the cost function that converges.

If, however, the cost function does not converge, then optimization engine 202 updates the trial state using the parameterized quantum circuit and the above-described process is repeated involving the aspects of measuring the output of the parameterized quantum circuit multiple times to obtain a set of samples using the updated trial state, calculating the expectation value using such a set of samples and further adjusting the parameters of the parameterized quantum circuit to minimize the cost function. That is, the cost function is minimized by iteratively updating the parameterized quantum circuit's parameters effectively tuning the quantum state outputted by the parameterized quantum circuit to achieve a desired outcome.

In one embodiment, “updating the trial state (quantum state that the parameterized circuit is designed to prepare) using the parameterized quantum circuit,” as used herein, refers to iteratively updating the initial guess for the quantum state by adjusting the parameters within the parameterized quantum circuit, such as a designed quantum circuit (ansatz), to minimize the cost function.

In this manner, multi-objective computational problems, such as multi-objective combinatorial optimization problems, where the solution is a Pareto front, may be solved without being computationally expensive using quantum computing.

Alternatively, in one embodiment, the principles of the present disclose solve a multi-objective computational problem, such as a multi-objective combinatorial optimization problem, where the solution is a Pareto front, without being computationally expensive using quantum computing using a Bayesian optimization approach as discussed below.

In one embodiment, the goal of such an approach is to enumerate the Pareto solutions from the constrained multi-objective optimization problem (MOP) solver framework for each bag. “Bag,” as used herein, refers to a collection of related items (objectives) that need to be optimized together based on certain criteria. This is represented by the following mathematical formula.

$${minimize}_{\begin{matrix}x ∈ {\{ 0 , 1 \}}^{n} \\ k ∈ \{ 1 , 2 , … , m \}\end{matrix}} {F}^{( k )} ( x ) = [ {f}_{distance} ( k , x ) , {f}_{time} ( k , x ) , {f}_{vehicle} ( k , x ) ]$$

$$subject to g ( k , x ) = 0$$

where x are the decision binary variables and k corresponds to the bag label (identification of which collection of related objectives are to be optimized together based on certain criteria).

As a result, objective functions and constraints are defined as follows for an exemplary electrical vehicle routing problem with the objectives of distance, time, and vehicle:

$${f}_{*} ( k , x ) = {c}_{*}^{( k )} \cdot x , * ∈ \{ distance , time , vehicle \}$$

$$g ( k , x ) = {A}^{( k )} x - b$$

where c^{(k)} is the coefficient vector of objectives, A^{(k)} is the coefficient matrix of constraints, and b^{(k)} is the RHS (right hand side) of linear constraints.

In one embodiment, in order to more efficiently utilize the MOP solver framework by incorporating a quantum algorithm, the following objective function is employed.

$$Input : k ∈ \{ 1 , 2 , … , m \} , x ∈ {S}^{( k )} = \{ x ∈ {\{ 0 , 1 \}}^{n} : {A}^{( k )} x = b \}$$

$$Output : {F}^{( k )} ( x )$$

where F^{(k)}(x) refers to the set of solutions on the Pareto front.

In one embodiment, the Pareto solutions are enumerated from the constrained multi-objective optimization problem (MOP) solver framework for each bag as discussed below.

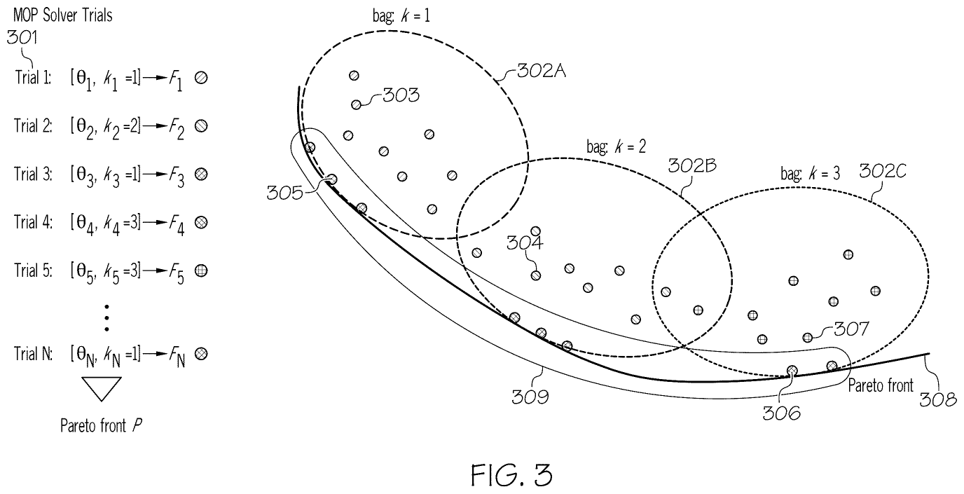

In one embodiment, classical computer 102 includes an initialization engine 203 configured to initialize the bag label k and circuit parameter θ. Such initialization is performed for each trail (MOP solver trial) as illustrated in FIG. 3. In one embodiment, initialization engine 203 initializes the circuit parameter θ for the parameterized quantum circuit for the trial based on the MOP solver, such as the Optuma samplers implementing multi-objective optimization.

FIG. 3 illustrates solving the set of solutions on the Pareto front based on performing MOP solver trials in accordance with an embodiment of the present disclosure.

As shown in FIG. 3, trials 301, such as trail 1 . . . trial N, where N is a positive integer number, are performed. Each trial involves solving a set of solutions for a multiple-objective function Fₖ for trial k involving objectives of a bag 302A, 302B, 302C (collection of objectives that need to be optimized together based on certain criteria) identified by a corresponding bag label k (identification of which collection of related objectives are to be optimized together based on certain criteria). Bags 302A-302C may collectively or individually be referred to as bags 302 or bag 302, respectively.

For example, as illustrated in FIG. 3, bag 302A is identified by bag label k=1. Furthermore, bag 302B is identified by bag label k=2 and bag 302C is identified by bag label k=3. While FIG. 3 illustrates three bags 302, it is noted that any number of bags may be utilized to identify the set of solutions on the Pareto front.

Furthermore, as illustrated in FIG. 3, each trial 301 involves the initialization of the circuit parameter θ for the parameterized quantum circuit. For example, trial 1 involves initializing the circuit parameter θ to be θ₁ for the bag label k₁=1 (bag 302A). The result of such a trial is a solution of the multiple-objective function Fₖ corresponding to F₁, where the solutions of multiple-objective function F₁ are represented by element 303. Similarly, trial 2 involves initializing the circuit parameter θ to be θ₂ for the bag label k₂=2 (bag 302B) resulting in the solution of the multiple-objective function Fₖ corresponding to F₂, where the solutions of multiple-objective function F₂ are represented by element 304, and so forth. For example, the solutions of multiple-objective function F₃ are represented by element 305, the solutions of multiple-objective function F₄ are represented by element 306, the solutions of multiple-objective function F₅ are represented by element 307, and so forth. Those solutions of the multiple-objective functions Fₖ that are aligned with Pareto front 308, such as solutions 309, correspond to the outputted set of solutions on the Pareto front.

Returning to FIG. 2, in conjunction with FIG. 3, after initialization of the bag label k and the circuit parameter θ for the parameterized quantum circuit for a particular trial 301 (e.g., trail 1), measurement engine 201 prepares a trial state (|φ(θ) [symbol] ) using a parameterized quantum circuit (e.g., quantum circuit 109), such as by designing an ansatz. In one embodiment, a suitable quantum circuit architecture with parameterized gates (e.g., rotation gates) is selected based on the multi-objective computational problem, such as a multi-objective combinatorial optimization problem, to be solved. In one embodiment, initial values are then assigned to the parameters in the ansatz. The parameterized quantum circuit is then run on a quantum computer (e.g., quantum computer 101) to prepare the trial state.

In one embodiment, measurement engine 201 measures the output of the parameterized quantum circuit multiple times to obtain a set of samples by executing the parameterized quantum circuit multiple times using the trial state.

In one embodiment, measurement engine 201 executes the parameterized quantum circuit with its set of parameters multiple times, where each run results in a single measurement outcome, which collectively forms the set of samples. As discussed further below, such a set of samples is used to calculate an expectation value that represents the average behavior of the parameterized quantum circuit under those parameters.

In one embodiment, at the end of each circuit execution, measurement engine 201 performs a measurement of the quantum state produced by the parameterized quantum circuit, which represents a point within the potential solution space (e.g., 303) of the multiple-objective function Fₖ (e.g., F₁) as shown in FIG. 3.

In one embodiment, measurement engine 201 executes the parameterized quantum circuit with the current parameter values on a quantum computer (e.g., quantum computer 101). The output quantum state of the parameterized quantum circuit is measured to obtain a single sample. Such a process is repeated for a predefined number of “shots” to collect a set of samples. Such a set of samples represents the set of candidate solutions that represents the feasible solution space of the multiple-objective function Fₖ.

Measurement engine 201 utilizes various software tools for preparing the trial state and measuring the output of the parameterized quantum circuit multiple times to obtain a set of samples as discussed above, including, but not limited to, Qiskit®, Cirq®, PennyLane®, etc.

Furthermore, measurement engine 201 is configured to calculate an expectation value ( [symbol] φ|H|φ [symbol] ), which acts as a cost function, using the set of samples. As previously discussed, an “expectation value,” as used herein, acts as a cost function by providing a single, weighted average value of all possible measurement results based on their probabilities.

In one embodiment, measurement engine 201 calculates the expectation value by taking the average of the measured outputs (samples) from the parameterized quantum circuit, where each sample represents a measurement of the quantum state produced by the parameterized quantum circuit with specific parameter settings weighted by the corresponding probability of that outcome.

Measurement engine 201 utilizes various software tools for calculating the expectation value in such a manner, including, but not limited to, SciPy, NumPy®, PyMOO, etc.

Furthermore, in one embodiment, optimization engine 202 adjusts the parameter (θ) of the parametrized quantum circuit to minimize the cost function. In one embodiment, optimization engine 202 utilizes classical computer 102 to adjust the parameters of the parametrized quantum circuit to minimize the cost function.

For example, in one embodiment, optimization engine 202 updates the parameter (θ) of the parameterized quantum circuit that aims to lower the cost function in the next iteration. That is, the cost function is minimized by iteratively updating the parameterized quantum circuit's parameter effectively tuning the quantum state outputted by the parameterized quantum circuit to achieve a desired outcome.

In one embodiment, optimization engine 202 updates the parameter (θ) of the parameterized quantum circuit to lower the cost function based on using the minimizer scipy.optimize.minimize (function in the SciPy® library used to find the minimum value of a scalar function of one or more variables).

In one embodiment, optimization engine 202 adjusts the parameter (θ) of the parameterized quantum circuit to minimize the expectation value, which acts as the cost function, by employing a classical optimization algorithm, such as gradient descent. In one embodiment, such parameters are updated based on the calculated gradient of the cost function with respect to those parameters.

In one embodiment, optimization engine 202 uses a technique, such as the parameter shift rule, to calculate the gradient of the cost function with respect to each parameter in the parameterized quantum circuit. Based on the calculated gradient, the parameters of the parameterized quantum circuit are updated in the direction that minimizes the cost function.

Furthermore, in one embodiment, optimization engine 202 determines if the cost function converges to find a suitable solution, where the “suitable solution” in this embodiment, as used herein, refers to the set of solutions for the multiple-objective function Fₖ for trial k.

In one embodiment, convergence is said to occur when the absolute difference in cost function values between consecutive iterations is less than a threshold value, which may be user-designated.

If the cost function does not converge, then the trial state is updated using the parameterized quantum circuit and the above-described process is repeated involving the aspects of measuring the output of the parameterized quantum circuit multiple times to obtain a set of samples using the updated trial state, calculating the expectation value using such a set of samples and further adjusting the parameter of the parameterized quantum circuit to minimize the cost function. That is, the cost function is minimized by iteratively updating the parameterized quantum circuit's parameter effectively tuning the quantum state outputted by the parameterized quantum circuit to achieve a desired outcome.

If, however, the cost function converges, optimization engine 202 outputs the set of solutions for the multiple-objective function Fₖ for trial k.

In one embodiment, optimization engine 202 may then determine if there are additional trials to be executed.

If there are additional trials to be executed, initialization engine 203 initializes the bag label k and circuit parameter θ for the parameterized quantum circuit for the next trial (e.g., k=2). In one embodiment, initialization engine 203 initializes the circuit parameter θ for the parameterized quantum circuit for the next trial based on the MOP solver, such as the Optuma samplers implementing multi-objective optimization.

After initializing the bag label k and circuit parameter θ for the parameterized quantum circuit for the next trial (e.g., k=2), the above-described process is repeated resulting in the output of the set of solutions for the multiple-objective function Fₖ (e.g., F₂) for trial k (e.g., k=2). Optimization engine 202 then determines if there are additional trials to be executed.

If, however, there are no further trials to be executed, then optimization engine 202 outputs the set of solutions 309 on Pareto front 308 corresponding to those previously outputted values for the multiple-objective function Fₖ for trial k that are located on Pareto front 308.

In this manner, multi-objective computational problems, such as muti-objective combinatorial optimization problems, where the solution is a Pareto front, can be solved in a less computationally expensive manner using quantum computing.

A further description of these and other functions is provided below in connection with the discussion of the method for solving multi-objective computational problems, such as muti-objective combinatorial optimization problems, where the solution is a Pareto front, in a less computationally expensive manner using quantum computing.

Prior to the discussion of the method for solving multi-objective computational problems, such as muti-objective combinatorial optimization problems, where the solution is a Pareto front, in a less computationally expensive manner using quantum computing, a description of the hardware configuration of classical computer 102 (FIG. 1) is provided below in connection with FIG. 4.

Referring now to FIG. 4, in conjunction with FIG. 1, FIG. 4 illustrates an embodiment of the present disclosure of the hardware configuration of classical computer 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 400 contains an example of an environment for the execution of at least some of the computer code 401 involved in performing the inventive methods, such as solving multi-objective problems, such as muti-objective combinatorial optimization problems, where the solution is a Pareto front, in a less computationally expensive manner using quantum computing. In addition to block 401, computing environment 400 includes, for example, classical computer 102, network 113, such as a wide area network (WAN), end user device (EUD) 402, remote server 403, public cloud 404, and private cloud 405. In this embodiment, classical computer 102 includes processor set 406 (including processing circuitry 407 and cache 408), communication fabric 409, volatile memory 410, persistent storage 411 (including operating system 412 and block 401, as identified above), peripheral device set 413 (including user interface (UI) device set 414, storage 415, and Internet of Things (IoT) sensor set 416), and network module 417. Remote server 403 includes remote database 418. Public cloud 404 includes gateway 419, cloud orchestration module 420, host physical machine set 421, virtual machine set 422, and container set 423.

Classical computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 418. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically classical computer 102, to keep the presentation as simple as possible. Classical computer 102 may be located in a cloud, even though it is not shown in a cloud in FIG. 4. On the other hand, classical computer 102 is not required to be in a cloud except to any extent as may be affirmatively indicated.

Processor set 406 includes one, or more, computer processors of any type now known or to be developed in the future. Processing circuitry 407 may be distributed over multiple packages, for example, multiple, coordinated integrated circuit chips. Processing circuitry 407 may implement multiple processor threads and/or multiple processor cores. Cache 408 is memory that is located in the processor chip package(s) and is typically used for data or code that should be available for rapid access by the threads or cores running on processor set 406. Cache memories are typically organized into multiple levels depending upon relative proximity to the processing circuitry. Alternatively, some, or all, of the cache for the processor set may be located “off chip.” In some computing environments, processor set 406 may be designed for working with qubits and performing quantum computing.

Computer readable program instructions are typically loaded onto classical computer 102 to cause a series of operational steps to be performed by processor set 406 of classical computer 102 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 408 and the other storage media discussed below. The program instructions, and associated data, are accessed by processor set 406 to control and direct performance of the inventive methods. In computing environment 400, at least some of the instructions for performing the inventive methods may be stored in block 401 in persistent storage 411.

Communication fabric 409 is the signal conduction paths that allow the various components of classical computer 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 410 is any type of volatile memory now known or to be developed in the future. Examples include dynamic type random access memory (RAM) or static type RAM. Typically, the volatile memory is characterized by random access, but this is not required unless affirmatively indicated. In classical computer 102, the volatile memory 410 is located in a single package and is internal to classical computer 102, but, alternatively or additionally, the volatile memory may be distributed over multiple packages and/or located externally with respect to classical computer 102.

Persistent Storage 411 is any form of non-volatile storage for computers that is now known or to be developed in the future. The non-volatility of this storage means that the stored data is maintained regardless of whether power is being supplied to classical computer 102 and/or directly to persistent storage 411. Persistent storage 411 may be a read only memory (ROM), but typically at least a portion of the persistent storage allows writing of data, deletion of data and re-writing of data. Some familiar forms of persistent storage include magnetic disks and solid state storage devices. Operating system 412 may take several forms, such as various known proprietary operating systems or open source Portable Operating System Interface type operating systems that employ a kernel. The code included in block 401 typically includes at least some of the computer code involved in performing the inventive methods.

Peripheral device set 413 includes the set of peripheral devices of classical computer 102. Data communication connections between the peripheral devices and the other components of classical computer 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 414 may include components such as a display screen, speaker, microphone, wearable devices (such as goggles and smart watches), keyboard, mouse, printer, touchpad, game controllers, and haptic devices. Storage 415 is external storage, such as an external hard drive, or insertable storage, such as an SD card. Storage 415 may be persistent and/or volatile. In some embodiments, storage 415 may take the form of a quantum computing storage device for storing data in the form of qubits. In embodiments where classical computer 102 is required to have a large amount of storage (for example, where classical computer 102 locally stores and manages a large database) then this storage may be provided by peripheral storage devices designed for storing very large amounts of data, such as a storage area network (SAN) that is shared by multiple, geographically distributed computers. IoT sensor set 416 is made up of sensors that can be used in Internet of Things applications. For example, one sensor may be a thermometer and another sensor may be a motion detector.

Network module 417 is the collection of computer software, hardware, and firmware that allows classical computer 102 to communicate with other computers through WAN 113. Network module 417 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 417 are performed on the same physical hardware device. In other embodiments (for example, embodiments that utilize software-defined networking (SDN)), the control functions and the forwarding functions of network module 417 are performed on physically separate devices, such that the control functions manage several different network hardware devices. Computer readable program instructions for performing the inventive methods can typically be downloaded to classical computer 102 from an external computer or external storage device through a network adapter card or network interface included in network module 417.

WAN 113 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 402 is any computer system that is used and controlled by an end user (for example, a customer of an enterprise that operates classical computer 102), and may take any of the forms discussed above in connection with classical computer 102. EUD 402 typically receives helpful and useful data from the operations of classical computer 102. For example, in a hypothetical case where classical computer 102 is designed to provide a recommendation to an end user, this recommendation would typically be communicated from network module 417 of classical computer 102 through WAN 113 to EUD 402. In this way, EUD 402 can display, or otherwise present, the recommendation to an end user. In some embodiments, EUD 402 may be a client device, such as thin client, heavy client, mainframe computer, desktop computer and so on.

Remote server 403 is any computer system that serves at least some data and/or functionality to classical computer 102. Remote server 403 may be controlled and used by the same entity that operates classical computer 102. Remote server 403 represents the machine(s) that collect and store helpful and useful data for use by other computers, such as classical computer 102. For example, in a hypothetical case where classical computer 102 is designed and programmed to provide a recommendation based on historical data, then this historical data may be provided to classical computer 102 from remote database 418 of remote server 403.

Public cloud 404 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 404 is performed by the computer hardware and/or software of cloud orchestration module 420. The computing resources provided by public cloud 404 are typically implemented by virtual computing environments that run on various computers making up the computers of host physical machine set 421, which is the universe of physical computers in and/or available to public cloud 404. The virtual computing environments (VCEs) typically take the form of virtual machines from virtual machine set 422 and/or containers from container set 423. It is understood that these VCEs may be stored as images and may be transferred among and between the various physical machine hosts, either as images or after instantiation of the VCE. Cloud orchestration module 420 manages the transfer and storage of images, deploys new instantiations of VCEs and manages active instantiations of VCE deployments. Gateway 419 is the collection of computer software, hardware, and firmware that allows public cloud 404 to communicate through WAN 113.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 405 is similar to public cloud 404, except that the computing resources are only available for use by a single enterprise. While private cloud 405 is depicted as being in communication with WAN 113 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 404 and private cloud 405 are both part of a larger hybrid cloud.

Block 401 further includes the software components discussed above in connection with FIGS. 2-3 to solve multi-objective computational problems, such as muti-objective combinatorial optimization problems, where the solution is a Pareto front, in a less computationally expensive manner using quantum computing. In one embodiment, such components may be implemented in hardware. The functions discussed above performed by such components are not generic computer functions. As a result, classical computer 102 is a particular machine that is the result of implementing specific, non-generic computer functions.

In one embodiment, the functionality of such software components of classical computer 102, including the functionality for solving multi-objective computational problems, such as muti-objective combinatorial optimization problems, where the solution is a Pareto front, in a less computationally expensive manner using quantum computing, may be embodied in an application-specific integrated circuit.

As stated above, a multi-objective computational problem is an optimization problem where you need to simultaneously optimize two or more conflicting objectives. That is, a multi-objective computational problem is an optimization problem where the improvement of one objective often comes at the expense of worsening another objective requiring one to find a balance or “trade-off” between them resulting in a set of “Pareto optimal” solutions (referred to as the “Pareto front”) rather than a single best solution. The solution to a multi-objective problem is typically represented by a set of Pareto optimal solutions (Pareto front), where no solution can be improved in one objective without worsening another. A Pareto front is a set of non-dominated solutions that are optimal in multi-objective optimization problems. That is, the Pareto front is a multi-dimensional and multi-objective equivalent of the optimal solution in single objective optimization problems. It is defined as the set of solutions that are non-dominated where no other solution strictly dominates them in terms of any objective. An example of a multi-objective computational problem, where the solution is the Pareto front, is an electrical vehicle routing problem with multiple objectives. The Pareto front represents a set of optimal solutions where it is impossible to improve one objective (e.g., minimizing travel distance) without worsening another objective (e.g., maximizing battery life) thereby illustrating the best trade-offs between competing goals when routing electric vehicles. Since electrical vehicle routing problems often involve minimizing both travel distance and energy consumption (which can be conflicting), it is typically treated as a multi-objective optimization problem, where the Pareto front identifies the set of solutions that cannot be improved in one objective without sacrificing the other. By visualizing the Pareto front, decision-makers can see which solutions offer the best balance between minimizing travel distance and maximizing battery life based on their specific needs. Examples of objectives in an electrical vehicle routing problem that might be included in a Pareto front include the total travel distance (e.g., minimizing the overall distance traveled by the electric vehicles), energy consumption (e.g., minimizing the total amount of energy used by the vehicles on their routes), and charging time (e.g., minimizing the time spent charging at charging stations). Such multi-objective computational problem, where the solution is a Pareto front, may be classified as NP (nondeterministic polynomial time)-hard problems. NP-hard problems are a class of computational problems that are extremely difficult to solve. When dealing with multi-objective optimization problems where multiple competing objectives need to be optimized simultaneously, finding the Pareto front (set of optimal solutions representing the best trade-offs between those objectives) can be a NP-hard problem (i.e., computationally challenging). Unfortunately, state of the art software tools to solve optimization problems, such as CPLEX®, are not capable of solving such NP-hard problems. Hence, there is not currently a means for finding the optimal solution for NP-hard problems, such as multi-objective computational problems where the solution is a Pareto front, without being computationally expensive.

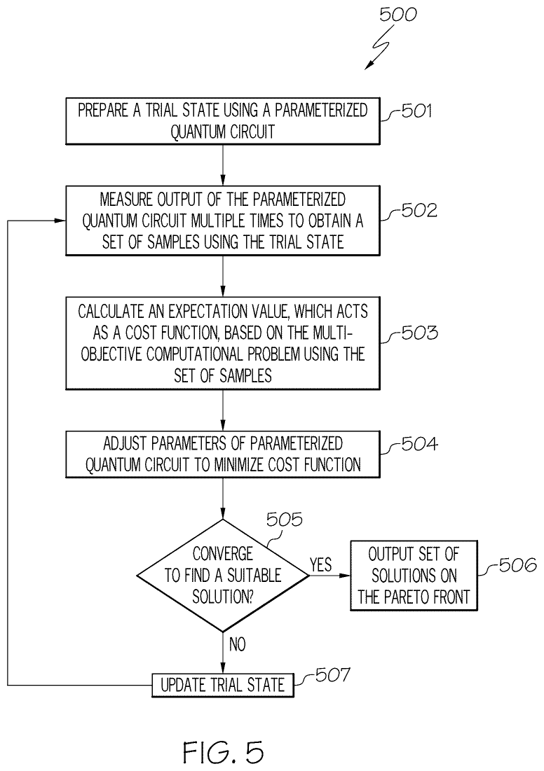

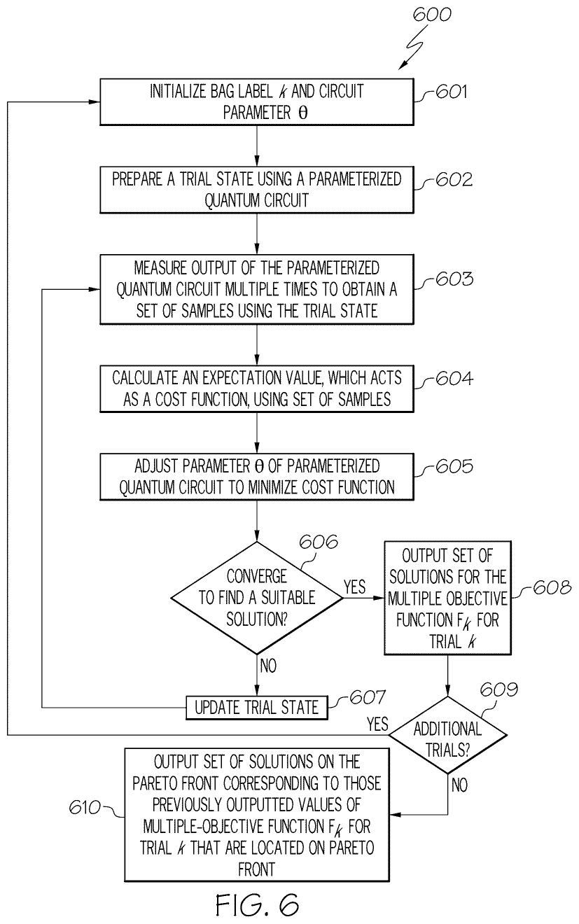

The embodiments of the present disclosure provide the means for finding the optimal solution for multi-objective computational problems, where the solution is a Pareto front, without being computationally expensive as discussed below in connection with FIGS. 5 and 6. FIG. 5 is a flowchart of a method for solving multi-objective computational problems, such as multi-objective combinatorial optimization problems, where the solution is a Pareto front, in a less computationally expensive manner using quantum computing. FIG. 6 is a flowchart of an alternative method for solving multi-objective computational problems, such as multi-objective combinatorial optimization problems, where the solution is a Pareto front, in a less computationally expensive manner using quantum computing.

As stated above, FIG. 5 is a flowchart of a method 500 for solving multi-objective computational problems, such as multi-objective combinatorial optimization problems, where the solution is a Pareto front, in a less computationally expensive manner using quantum computing. in accordance with an embodiment of the present disclosure.

Referring to FIG. 5, in conjunction with FIGS. 1-4, in step 501, measurement engine 201 prepares a trial state using a parameterized quantum circuit (e.g., quantum circuit 109).

As stated above, a “trial state,” as used herein, refers to an initial guess for the quantum state to be found, which is then refined through optimization. A “parameterized quantum circuit,” as used herein, refers to a quantum circuit where certain gates or operations contain adjustable parameters allowing the circuit's behavior to be fine-tuned by changing the values of these parameters.

In one embodiment, measurement engine 201 prepares a trial state using a parameterized quantum circuit by designing an ansatz. The ansatz, as used herein, refers to the specific structure of the parameterized quantum circuit used to prepare the trial state. In one embodiment, a suitable quantum circuit architecture with parameterized gates (e.g., rotation gates) is selected based on the problem, such as a multi-objective combinatorial optimization problem, to be solved. In one embodiment, initial values are then assigned to the parameters in the ansatz. The parameterized quantum circuit is then run on a quantum computer (e.g., quantum computer 101) to prepare the trial state.

In step 502, measurement engine 201 measures the output of the parameterized quantum circuit multiple times to obtain a set of samples by executing the parameterized quantum circuit multiple times using the trial state.

As stated above, a “set of samples,” as used herein, represents the probability distribution of the parameterized quantum circuit's outputs. In one embodiment, each sample of the set of samples represents a point within the potential solution space of the multi-objective computational problem.

In one embodiment, measurement engine 201 executes the parameterized quantum circuit with its set of parameters multiple times, where each run results in a single measurement outcome, which collectively forms the set of samples. As discussed further below, such a set of samples is used to calculate an expectation value that represents the average behavior of the parameterized quantum circuit under those parameters.

In one embodiment, at the end of each circuit execution, measurement engine 201 performs a measurement of the quantum state produced by the parameterized quantum circuit, which represents a point within the potential solution space of the multi-objective computational problem. In one embodiment, such a point corresponds to a bitstring that belongs to the Pareto front. In one embodiment, the bitstrings of the Pareto front in a multi-objective computational problem, such as a multi-objective combinatorial optimization problem, represent the solutions on the Pareto front, where each bit in the string corresponds to a decision variable in the problem. The set of all such bitstrings on the Pareto front represents the optimal trade-offs between different objectives without any solution being strictly dominated by another.

In one embodiment, measurement engine 201 executes the parameterized quantum circuit with the current parameter values on a quantum computer (e.g., quantum computer 101). The output quantum state of the parameterized quantum circuit is measured to obtain a single sample. Such a process is repeated for a predefined number of “shots” to collect a set of samples. Such a set of samples represents the set of candidate solutions that represents the feasible solution space of the multi-objective computational problem, such as the multi-objective combinatorial optimization problem.

Measurement engine 201 utilizes various software tools for preparing the trial state and measuring the output of the parameterized quantum circuit multiple times to obtain a set of samples as discussed above, including, but not limited to, Qiskit®, Cirq®, PennyLane®, etc.

In step 503, measurement engine 201 calculates an expectation value, which acts as a cost function, based on the multi-objective computational problem, such as the multi-objective combinatorial optimization problem, using the set of samples.

As discussed above, an “expectation value,” as used herein, acts as a cost function by providing a single, weighted average value of all possible measurement results based on their probabilities.

In one embodiment, measurement engine 201 calculates the expectation value by taking the average of the measured outputs (samples) from the parameterized quantum circuit, where each sample represents a measurement of the quantum state produced by the parameterized quantum circuit with specific parameter settings weighted by the corresponding probability of that outcome.

Measurement engine 201 utilizes various software tools for calculating the expectation value in such a manner, including, but not limited to, SciPy, NumPy®, PyMOO, etc.

In step 504, optimization engine 202 adjusts the parameters of the parametrized quantum circuit to minimize the cost function.

As stated above, in one embodiment, optimization engine 202 utilizes classical computer 102 to adjust the parameters of the parametrized quantum circuit to minimize the cost function.

For example, in one embodiment, optimization engine 202 updates the parameters (θ) of the parameterized quantum circuit that aim to lower the cost function in the next iteration. That is, the cost function is minimized by iteratively updating the parameterized quantum circuit's parameters effectively tuning the quantum state outputted by the parameterized quantum circuit to achieve a desired outcome.

In one embodiment, optimization engine 202 performs such an optimization which is mathematically shown below.

$$ℒ ( \vec{θ} ) = {\sum }_{{\vec{x}}_{i} ∈ S} [ p ( {\vec{x}}_{i} ; \vec{θ} ) ( \frac{1}{\vert Q \vert + 1} {\sum }_{k = 1}^{K} {\sum }_{{x}_{j} ∈ Q} sign ( {f}_{k} ( {\vec{x}}_{i} ) - {f}_{k} ( {\vec{x}}_{j} ) ) + λ {‖ A {\vec{x}}_{i} - \vec{b} ‖}^{2} ) ] ,$$

$$sign ( a ) = \{ \begin{matrix}- 1 & if a \leq 0 \\ 1 & if a > 0\end{matrix} , and$$

$$Q = \{ {\vec{x}}_{j} ∈ S : {f}_{k} ( {\vec{x}}_{j} ) \geq {f}_{k} ( {\vec{u}}_{j} ) ∀ K ∈ [ 1 … K ] or {f}_{k} ( {\vec{x}}_{j} ) \leq {f}_{k} ( {\vec{x}}_{i} ) ∀ K ∈ [ 1 … K ] ,$$

where matrix A and \vec{b} define the constraints of the multi-objective computational problem, such as the multi-objective combinatorial optimization problem, fₖ are the objective functions, and \vec{x} denotes a bitstring.

In one embodiment, optimization engine 202 adjusts the parameters of the parameterized quantum circuit to minimize the expectation value, which acts as the cost function, by employing a classical optimization algorithm, such as gradient descent. In one embodiment, such parameters are updated based on the calculated gradient of the cost function with respect to those parameters.

In one embodiment, optimization engine 202 uses a technique, such as the parameter shift rule, to calculate the gradient of the cost function with respect to each parameter in the parameterized quantum circuit. Based on the calculated gradient, the parameters of the parameterized quantum circuit are updated in the direction that minimizes the cost function.

In step 505, optimization engine 202 determines if the cost function converges to find a suitable solution, where the “suitable solution” in this embodiment, as used herein, refers to the set of solutions on the Pareto front. In one embodiment, the set of solutions on the Pareto front corresponds to the set of samples (representing the feasible solution space of the multi-objective computational problem, such as the multi-objective combinatorial optimization problem) that was used to calculate the expectation value, which acts as the cost function that converges.

In one embodiment, convergence is said to occur when the absolute difference in cost function values between consecutive iterations is less than a threshold value, which may be user-designated.

If the cost function converges, then, in step 506, optimization engine 202 outputs the set of solutions on the Pareto front, which corresponds to the set of samples (representing the feasible solution space of the multi-objective computational problem, such as the multi-objective combinatorial optimization problem) that was used to calculate the expectation value, which acted as the cost function that converges.

If, however, the cost function does not converge, then, in step 507, optimization engine 202 updates the trial state using the parameterized quantum circuit and the above-described process is repeated involving the aspects of measuring the output of the parameterized quantum circuit multiple times to obtain a set of samples using the updated trial state, calculating the expectation value using such a set of samples and further adjusting the parameters of the parameterized quantum circuit to minimize the cost function. That is, the cost function is minimized by iteratively updating the parameterized quantum circuit's parameters effectively tuning the quantum state outputted by the parameterized quantum circuit to achieve a desired outcome.

In one embodiment, “updating the trial state (quantum state that the parameterized circuit is designed to prepare) using the parameterized quantum circuit,” as used herein, refers to iteratively updating the initial guess for the quantum state by adjusting the parameters within the parameterized quantum circuit, such as a designed quantum circuit (ansatz), to minimize the cost function.

In this manner, multi-objective computational problems, such as muti-objective combinatorial optimization problems, where the solution is a Pareto front, can be solved in a less computationally expensive manner using quantum computing.

Alternatively, in one embodiment, the principles of the present disclose solve a multi-objective computational problem, such as a multi-objective combinatorial optimization problem, where the solution is a Pareto front, using quantum computing using a Bayesian optimization approach as discussed below in connection with FIG. 6.

FIG. 6 is a flowchart of an alternative method 600 for solving multi-objective computational problems, such as multi-objective combinatorial optimization problems, where the solution is a Pareto front, in a less computationally expensive manner using quantum computing in accordance with an embodiment of the present disclosure.

Referring to FIG. 6, in conjunction with FIGS. 1-5, in step 601, initialization engine 203 initializes the bag label k and circuit parameter θ.

As discussed above, such initialization is performed for each trail (MOP solver trial) as illustrated in FIG. 3. In one embodiment, initialization engine 203 initializes the circuit parameter θ for the parameterized quantum circuit for the trial based on the MOP solver, such as the Optuma samplers implementing multi-objective optimization.

As shown in FIG. 3, trials 301, such as trail 1 . . . trial N, where N is a positive integer number, are performed. Each trial involves solving a set of solutions for a multiple-objective function Fₖ for trial k involving objectives of a bag 302A, 302B, 302C (collection of objectives that need to be optimized together based on certain criteria) identified by a corresponding bag label k (identification of which collection of related objectives are to be optimized together based on certain criteria).

For example, as illustrated in FIG. 3, bag 302A is identified by bag label k=1. Furthermore, bag 302B is identified by bag label k=2 and bag 302C is identified by bag label k=3. While FIG. 3 illustrates three bags 302, it is noted that any number of bags may be utilized to identify the set of solutions on the Pareto front.

Furthermore, as illustrated in FIG. 3, each trial 301 involves the initialization of the circuit parameter θ for the parameterized quantum circuit. For example, trial 1 involves initializing the circuit parameter θ to be θ₁ for the bag label k₁=1 (bag 302A). The result of such a trial is a solution of the multiple-objective function Fₖ corresponding to F₁, where the solutions of multiple-objective function F₁ are represented by element 303. Similarly, trial 2 involves initializing the circuit parameter θ to be θ₂ for the bag label k₂=2 (bag 302B) resulting in the solution of the multiple-objective function Fₖ corresponding to F₂, where the solutions of multiple-objective function F₂ are represented by element 304, and so forth. For example, the solutions of multiple-objective function F₃ are represented by element 305, the solutions of multiple-objective function F₄ are represented by element 306, the solutions of multiple-objective function F₅ are represented by element 307, and so forth. Those solutions of the multiple-objective functions Fₖ that are aligned with Pareto front 308, such as solutions 309, correspond to the outputted set of solutions on the Pareto front.

In step 602, after initialization of the bag label k and the circuit parameter θ for the parameterized quantum circuit for a particular trial 301 (e.g., trail 1), measurement engine 201 prepares a trial state (|φ(θ) [symbol] ) using a parameterized quantum circuit (e.g., quantum circuit 109), such as by designing an ansatz.

As stated above, in one embodiment, a suitable quantum circuit architecture with parameterized gates (e.g., rotation gates) is selected based on the multi-objective computational problem, such as a multi-objective combinatorial optimization problem, to be solved. In one embodiment, initial values are then assigned to the parameters in the ansatz. The parameterized quantum circuit is then run on a quantum computer (e.g., quantum computer 101) to prepare the trial state.

In step 603, measurement engine 201 measures the output of the parameterized quantum circuit multiple times to obtain a set of samples by executing the parameterized quantum circuit multiple times using the trial state.

As discussed above, in one embodiment, measurement engine 201 executes the parameterized quantum circuit with its set of parameters multiple times, where each run results in a single measurement outcome, which collectively forms the set of samples. As discussed further below, such a set of samples is used to calculate an expectation value that represents the average behavior of the parameterized quantum circuit under those parameters.

In one embodiment, at the end of each circuit execution, measurement engine 201 performs a measurement of the quantum state produced by the parameterized quantum circuit, which represents a point within the potential solution space (e.g., 303) of the multiple-objective function Fₖ (e.g., F₁) as shown in FIG. 3.

In one embodiment, measurement engine 201 executes the parameterized quantum circuit with the current parameter values on a quantum computer (e.g., quantum computer 101). The output quantum state of the parameterized quantum circuit is measured to obtain a single sample. Such a process is repeated for a predefined number of “shots” to collect a set of samples. Such a set of samples represents the set of candidate solutions that represents the feasible solution space of the multiple-objective function Fₖ.

Measurement engine 201 utilizes various software tools for preparing the trial state and measuring the output of the parameterized quantum circuit multiple times to obtain a set of samples as discussed above, including, but not limited to, Qiskit®, Cirq®, PennyLane®, etc.

In step 604, measurement engine 201 calculates an expectation value ( [symbol] φ|H|φ [symbol] ), which acts as a cost function, using the set of samples. As previously discussed, an “expectation value,” as used herein, acts as a cost function by providing a single, weighted average value of all possible measurement results based on their probabilities.

In one embodiment, measurement engine 201 calculates the expectation value by taking the average of the measured outputs (samples) from the parameterized quantum circuit, where each sample represents a measurement of the quantum state produced by the parameterized quantum circuit with specific parameter settings weighted by the corresponding probability of that outcome.

Measurement engine 201 utilizes various software tools for calculating the expectation value in such a manner, including, but not limited to, SciPy, NumPy®, PyMOO, etc.

In step 605, optimization engine 202 adjusts the parameter (θ) of the parametrized quantum circuit to minimize the cost function. In one embodiment, optimization engine 202 utilizes classical computer 102 to adjust the parameters of the parametrized quantum circuit to minimize the cost function.

For example, in one embodiment, optimization engine 202 updates the parameter (θ) of the parameterized quantum circuit that aims to lower the cost function in the next iteration. That is, the cost function is minimized by iteratively updating the parameterized quantum circuit's parameter effectively tuning the quantum state outputted by the parameterized quantum circuit to achieve a desired outcome.

In one embodiment, optimization engine 202 updates the parameter (θ) of the parameterized quantum circuit to lower the cost function based on using the minimizer scipy.optimize.minimize (function in the SciPy® library used to find the minimum value of a scalar function of one or more variables).

In one embodiment, optimization engine 202 adjusts the parameter (θ) of the parameterized quantum circuit to minimize the expectation value, which acts as the cost function, by employing a classical optimization algorithm, such as gradient descent. In one embodiment, such parameters are updated based on the calculated gradient of the cost function with respect to those parameters.

In one embodiment, optimization engine 202 uses a technique, such as the parameter shift rule, to calculate the gradient of the cost function with respect to each parameter in the parameterized quantum circuit. Based on the calculated gradient, the parameters of the parameterized quantum circuit are updated in the direction that minimizes the cost function.

In step 606, optimization engine 202 determines if the cost function converges to find a suitable solution, where the “suitable solution” in this embodiment, as used herein, refers to the set of solutions for the multiple-objective function Fₖ for trial k.

In one embodiment, convergence is said to occur when the absolute difference in cost function values between consecutive iterations is less than a threshold value, which may be user-designated.

If the cost function does not converge, then, in step 607, optimization engine 202 updates the trial state using the parameterized quantum circuit and the above-described process is repeated involving the aspects of measuring the output of the parameterized quantum circuit multiple times to obtain a set of samples using the updated trial state, calculating the expectation value using such a set of samples and further adjusting the parameter of the parameterized quantum circuit to minimize the cost function. That is, the cost function is minimized by iteratively updating the parameterized quantum circuit's parameter effectively tuning the quantum state outputted by the parameterized quantum circuit to achieve a desired outcome.

If, however, the cost function converges, then, in step 608, optimization engine 202 outputs the set of solutions for the multiple-objective function Fₖ for trial k.

In step 609, optimization engine 202 determines if there are additional trials to be executed.

If there are additional trials to be executed, then initialization engine 203 initializes the bag label k and circuit parameter θ for the parameterized quantum circuit for the next trial (e.g., k=2) in step 601. In one embodiment, initialization engine 203 initializes the circuit parameter θ for the parameterized quantum circuit for the next trial based on the MOP solver, such as the Optuma samplers implementing multi-objective optimization.

After initializing the bag label k and circuit parameter θ for the parameterized quantum circuit for the next trial (e.g., k=2), the above-described process is repeated resulting in the output of the set of solutions for the multiple-objective function Fₖ (e.g., F₂) for trial k (e.g., k=2). Optimization engine 202 then determines if there are additional trial to be executed.

If, however, there are no further trials to be executed, then, in step 610, optimization engine 202 outputs the set of solutions 309 on Pareto front 308 corresponding to those previously outputted values for the multiple-objective function Fₖ for trial k that are located on Pareto front 308.

In this manner, multi-objective computational problems, such as muti-objective combinatorial optimization problems, where the solution is a Pareto front, can be solved in a less computationally expensive manner using quantum computing.

Furthermore, the principles of the present disclosure improve the technology or technical field involving multiple-objective computational problems.

As discussed above, a multi-objective computational problem is an optimization problem where you need to simultaneously optimize two or more conflicting objectives. That is, a multi-objective computational problem is an optimization problem where the improvement of one objective often comes at the expense of worsening another objective requiring one to find a balance or “trade-off” between them resulting in a set of “Pareto optimal” solutions (referred to as the “Pareto front”) rather than a single best solution. The solution to a multi-objective problem is typically represented by a set of Pareto optimal solutions (Pareto front), where no solution can be improved in one objective without worsening another. A Pareto front is a set of non-dominated solutions that are optimal in multi-objective optimization problems. That is, the Pareto front is a multi-dimensional and multi-objective equivalent of the optimal solution in single objective optimization problems. It is defined as the set of solutions that are non-dominated where no other solution strictly dominates them in terms of any objective. An example of a multi-objective computational problem, where the solution is the Pareto front, is an electrical vehicle routing problem with multiple objectives. The Pareto front represents a set of optimal solutions where it is impossible to improve one objective (e.g., minimizing travel distance) without worsening another objective (e.g., maximizing battery life) thereby illustrating the best trade-offs between competing goals when routing electric vehicles. Since electrical vehicle routing problems often involve minimizing both travel distance and energy consumption (which can be conflicting), it is typically treated as a multi-objective optimization problem, where the Pareto front identifies the set of solutions that cannot be improved in one objective without sacrificing the other. By visualizing the Pareto front, decision-makers can see which solutions offer the best balance between minimizing travel distance and maximizing battery life based on their specific needs. Examples of objectives in an electrical vehicle routing problem that might be included in a Pareto front include the total travel distance (e.g., minimizing the overall distance traveled by the electric vehicles), energy consumption (e.g., minimizing the total amount of energy used by the vehicles on their routes), and charging time (e.g., minimizing the time spent charging at charging stations). Such multi-objective computational problem, where the solution is a Pareto front, may be classified as NP (nondeterministic polynomial time)-hard problems. NP-hard problems are a class of computational problems that are extremely difficult to solve. When dealing with multi-objective optimization problems where multiple competing objectives need to be optimized simultaneously, finding the Pareto front (set of optimal solutions representing the best trade-offs between those objectives) can be a NP-hard problem (i.e., computationally challenging). Unfortunately, state of the art software tools to solve optimization problems, such as CPLEX®, are not capable of solving such NP-hard problems. Hence, there is not currently a means for finding the optimal solution for NP-hard problems, such as multi-objective computational problems where the solution is a Pareto front, without being computationally expensive.

Embodiments of the present disclosure improve such technology by measuring the output of a parameterized quantum circuit multiple times to obtain a set of samples, where each sample of the set of samples represents a point within a potential solution space of the multi-objective computational problem. A parameterized quantum circuit, as used herein, refers to a quantum circuit where certain gates or operations contain adjustable parameters allowing the circuit's behavior to be fine-tuned by changing the values of these parameters. A set of samples, as used herein, represents the probability distribution of the parameterized quantum circuit's outputs. An expectation value, which acts as a cost function, is calculated based on the multi-objective computational problem using the set of samples. In one embodiment, the expectation value is calculated by taking the average of the measured outputs (samples) from the parameterized quantum circuit. An expectation value, as used herein, acts as a cost function by providing a single, weighted average value of all possible measurement results based on their probabilities. The classical computer may then be utilized to adjust the parameters of the parameterized quantum circuit to minimize the cost function. For example, in one embodiment, the calculated cost function is fed into a classical optimizer which updates the circuit parameters (θ) that aim to lower the cost function in the next iteration. That is, the cost function is minimized by iteratively updating the parameterized quantum circuit's parameters effectively tuning the quantum state outputted by the parameterized quantum circuit to achieve a desired outcome. A set of solutions on the Pareto front corresponding to a set of samples is then outputted by the classical computer in response to a convergence of the cost function, where such a set of samples was used to calculate the expectation value which acted as the cost function. In one embodiment, convergence is said to occur when the absolute difference in cost function values between consecutive iterations is less than a threshold value, which may be user-designated. In this manner, multi-objective computational problems where the solution is a Pareto front may be solved being computationally expensive using quantum computing. Furthermore, in this manner, there is an improvement in the technical field involving multiple-objective computational problems.

Furthermore, embodiments of the present disclosure improve such technology by measuring the output of a parameterized quantum circuit multiple times to obtain a set of samples, where the set of samples represents a set of candidate solutions that represents a feasible solution space of a multiple-objective function of the multi-objective computational problem for a trial. The expectation value, which acts as a cost function, is then calculated using the set of samples. The classical computer may then be utilized to adjust the parameter of the parameterized quantum circuit to minimize the cost function. The cost function is minimized by iteratively updating the parameterized quantum circuit's parameter effectively tuning the quantum state outputted by the parameterized quantum circuit to achieve a desired outcome. A set of solutions (corresponds to the set of samples used to calculate the expectation value which acts as the cost function) for the multiple-objective function of the multi-objective computational problem for the trail is then outputted in response to a convergence of the cost function. The above-described process is repeated for other trials until there are no further trials to be executed. Upon executing all the trials, the set of solutions on the Pareto front corresponding to those previously outputted values for multiple-objective function Fₖ for trial k that are located on the Pareto front are outputted. In this manner, multi-objective computational problems where the solution is a Pareto front may be solved without being computationally expensive using quantum computing. Furthermore, in this manner, there is an improvement in the technical field involving multiple-objective computational problems.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for solving multi-objective computational problems, the method comprising:
measuring output of a parameterized quantum circuit multiple times to obtain a set of samples, wherein each sample of said set of samples represents a point within a potential solution space of a multi-objective computational problem;
calculating an expectation value, which acts as a cost function, using said set of samples;
adjusting parameters of said parameterized quantum circuit to minimize said cost function; and
outputting a set of solutions on a Pareto front in response to a convergence of said cost function.

2. The method as recited in claim 1 further comprising;
preparing a trial state using said parameterized quantum circuit.

3. The method as recited in claim 2 further comprising:
measuring said output of said parameterized quantum circuit multiples times to obtain said set of samples by executing said parameterized quantum circuit multiple times using said trial state.

4. The method as recited in claim 2 further comprising:
updating said trial state in response to said cost function not converging.

5. The method as recited in claim 4 further comprising:
measuring said output of said parameterized quantum circuit multiples times to obtain a second set of samples by executing said parameterized quantum circuit multiple times using said updated trial state.

6. The method as recited in claim 1, wherein said cost function converges in response to an absolute difference in cost function values between consecutive iterations being less than a threshold value.

7. A method for solving multi-objective computational problems, the method comprising:
measuring output of a parameterized quantum circuit multiple times to obtain a first set of samples, wherein said first set of samples represents a first set of candidate solutions that represents a feasible solution space of a first multiple-objective function of a multi-objective computational problem for a first trial;
calculating an expectation value, which acts as a cost function, using said first set of samples;
adjusting a parameter of said parameterized quantum circuit to minimize said cost function; and
outputting a first set of solutions for said first multiple-objective function of said multi-objective computational problem for said first trial in response to a convergence of said cost function.

8. The method as recited in claim 7 further comprising:
preparing a trial state using said parameterized quantum circuit.

9. The method as recited in claim 8 further comprising:
measuring said output of said parameterized quantum circuit multiple times to obtain said first set of samples by executing said parameterized quantum circuit multiple times using said trial state.

10. The method as recited in claim 8 further comprising:
updating said trial state in response to said cost function not converging.

11. The method as recited in claim 10 further comprising:
measuring said output of said parameterized quantum circuit multiple times to obtain a second set of samples by executing said parameterized quantum circuit multiple times using said updated trial state, wherein said second set of samples represents a second set of candidate solutions that represents a feasible solution space of a second multiple-objective function of said multi-objective computational problem for a second trial.

12. The method as recited in claim 7 further comprising:
measuring said output of said parameterized quantum circuit multiple times to obtain a second set of samples, wherein said second set of samples represents a second set of candidate solutions that represents a feasible solution space of a second multiple-objective function of said multi-objective computational problem for a second trial;
calculating said expectation value, which acts as said cost function, using said second set of samples;
adjusting said parameter of said parameterized quantum circuit to minimize said cost function; and
outputting a second set of solutions for said second multiple-objective function of said multi-objective computational problem for said second trial in response to a convergence of said cost function.

13. The method as recited in claim 12 further comprising:
outputting a set of solutions on a Pareto front corresponding to those previously outputted values for said first and second multiple-objective functions that are located on said Pareto front.

14. A computer program product for solving multi-objective computational problems, the computer program product comprising one or more computer readable storage mediums having program code embodied therewith, the program code comprising programming instructions for:
measuring output of a parameterized quantum circuit multiple times to obtain a first set of samples, wherein said first set of samples represents a first set of candidate solutions that represents a feasible solution space of a first multiple-objective function of a multi-objective computational problem for a first trial;
calculating an expectation value, which acts as a cost function, using said first set of samples;
adjusting a parameter of said parameterized quantum circuit to minimize said cost function; and
outputting a first set of solutions for said first multiple-objective function of said multi-objective computational problem for said first trial in response to a convergence of said cost function.

15. The computer program product as recited in claim 14, wherein the program code further comprises the programming instructions for:
preparing a trial state using said parameterized quantum circuit.

16. The computer program product as recited in claim 15, wherein the program code further comprises the programming instructions for:
measuring said output of said parameterized quantum circuit multiple times to obtain said first set of samples by executing said parameterized quantum circuit multiple times using said trial state.

17. The computer program product as recited in claim 15, wherein the program code further comprises the programming instructions for:
updating said trial state in response to said cost function not converging.

18. The computer program product as recited in claim 17, wherein the program code further comprises the programming instructions for:
measuring said output of said parameterized quantum circuit multiple times to obtain a second set of samples by executing said parameterized quantum circuit multiple times using said updated trial state, wherein said second set of samples represents a second set of candidate solutions that represents a feasible solution space of a second multiple-objective function of said multi-objective computational problem for a second trial.

19. The computer program product as recited in claim 14, wherein the program code further comprises the programming instructions for:
measuring said output of said parameterized quantum circuit multiple times to obtain a second set of samples, wherein said second set of samples represents a second set of candidate solutions that represents a feasible solution space of a second multiple-objective function of said multi-objective computational problem for a second trial;
calculating said expectation value, which acts as said cost function, using said second set of samples;
adjusting said parameter of said parameterized quantum circuit to minimize said cost function; and
outputting a second set of solutions for said second multiple-objective function of said multi-objective computational problem for said second trial in response to a convergence of said cost function.

20. The computer program product as recited in claim 19, wherein the program code further comprises the programming instructions for:
outputting a set of solutions on a Pareto front corresponding to those previously outputted values for said first and second multiple-objective functions that are located on said Pareto front.
